(19) United States
(12) Patent Application Publication
(10) Pub. No.: US 2016/0189113 A1
(43) Pub. Date: Jun. 30, 2016

(54) PIGGYBACK EVENT

(71) Applicants: JOSEPH ALBERT TARANTINO, EL CAJON, CA (US); DOMINIC FRANCESCO TARANTINO, EL CAJON, CA (US)

(72) Inventors: JOSEPH ALBERT TARANTINO, EL CAJON, CA (US); DOMINIC FRANCESCO TARANTINO, EL CAJON, CA (US)

(21) Appl. No.: 14/968,877

(22) Filed: Dec. 14, 2015

Related U.S. Application Data
(60) Provisional application No. 62/098,220, filed on Dec. 30, 2014.

(51) Int. Cl. G06Q 10/10; G06Q 50/00; H04L 12/58

(52) U.S. Cl. CPC G06Q 10/1095; H04L 51/32; G06Q 50/01

(57) ABSTRACT

A method of creating a sub-event(s) based on a pre-existing event allows users to connect and transact by sending a private message or public post to a selected group of users on a social network.

### CROSS-REFERENCE TO RELATED APPLICATIONS

This application claims the benefit of U.S. Provisional Application No. 62/098,220 filed on Dec. 30, 2014.

### FIELD OF THE INVENTION

The present invention is related to social networking events and more particularly is directed to a method of creating one or more sub-event(s) based on a pre-existing event that allows users to connect and transact by sending a private message or public post to a selected group of users on a social network. Also, the invention provides a way for one or more persons or artificially intelligent entities to organize event subsets. Furthermore, the invention provides organization, syndication, and hosting of a wide range of offshoot events such as forums, parties, meetings, festivals, concerts, lectures, get-togethers, and the like, that are related to, but are not an integral part of, the main pre-existing event.

### BACKGROUND

The following description is not an admission that any of the information provided herein is prior art or relevant to the present invention, or that any publication specifically or implicitly referenced is prior art. Any publications cited in this description are incorporated by reference herein. Where a definition or use of a term in an incorporated reference is inconsistent or contrary to the definition of that term provided herein, the definition of that term provided herein applies and the definition of that term in the reference does not apply.

Many top tier social networks such as Facebook, LinkedIn, or the like, allow their users comprising professionals, college and high school students, family members or individuals with common interests or with the same technical expertise, to connect and share information and experiences. Such networks are limited because none provides a unique way to pluralize pre-existing events for either recreational or business purposes that is mutually beneficial to all users. Accordingly, there is an unmet need for event management tools to host and organize smaller, offshoot events.

### SUMMARY OF THE INVENTION

The present invention is directed to a method of creating one or more sub-even based on a pre-existing event that allows users to connect and transact by sending a private message or public post to a selected group of users on a social network. In an embodiment, the invention provides a way for one or more persons or artificially intelligent entities to organize related (or even unrelated) event subsets. In another embodiment, the invention helps to organize, syndicate, make known and host a wide range of offshoot events such as forums, parties, meetings, festivals, concerts, lectures, get-togethers, and the like that are related to, but are not an integral part of, the main pre-existing event.

One or more embodiments of the present invention also provides user-to-user interaction by providing opportunities for individuals from diverse geographical locations to share their experience of an event with those individuals who cannot physically attend the same event. Furthermore, an embodiment of the present invention also provides a method of pluralizing events as an entertaining or fun way to create events on themes of larger official events. For example, while the soccer (also known as football) World Cup may be held in Brazil and FIFA has created an official “World Cup Brazil YYYY” page, people around the world may use the official page as a way to host a party on the theme of the World Cup at a place of business, virtual meeting place, public space or private residence. Also, by way of example, the popular tradeshow Comic Con may be held at the San Diego Convention Center (SDCC). While SDCC may have its own ticketing mechanism for admission into official event spaces onsite, a plethora of subset events will inevitably occur between persons or other entities that are related to the main Comic Con event. Such sub-events, which are based on the theme of Comic Con, may occur at the physical location of the SDCC, at an online forum, or at various locations in the area. This brings attention to a wider range of related Comic Con events that may have been previously unknown to people and event attendees as well as third party applications to access.

In an embodiment, the third party applications can be any existing or future web or mobile application that may be granted access to certain information shared between the event organizer, viewer or discoverer, and the piggyback event created. For instance, a social application may request access to event time, location, guest list, and the like, for sharing or syndication. In another embodiment, the third party application may be an application that is not social but that offers a service that provides communication with the organizer or viewer, such as Uber, the revolutionary business that connects drivers to riders via a mobile application.

In an exemplary embodiment, a computer-implemented method for creating one or more sub-events in a social network comprises creating main events by an event organizer while said event organizer is viewing his/her account, an event feed, or any other page within a website, redirecting the event organizer to an interface that allows the event organizer to create or revise the main event, prompting the event organizer to allow one or more sub-events to be created on the event organizer's event page, authorizing an event viewer to enter the social network homepage, wherein the event viewer receives an invitation for one or more sub-events created by said main event, and allowing the event viewer to create a sub-event page and optionally allowing the event viewer to observe limited details about the sub-events page created by a plurality of event viewers in relation to the main event.

In a further embodiment, the main event is a customized event webpage displaying the details of the main event comprising date, time, and location.

In still another embodiment, the user is one or more persons or artificially intelligent entities.

In another embodiment, the event organizer does not control who creates the sub-events and the type of the sub-events.

In a further embodiment, the event viewer discovers the main event through a shared link or a third party application, wherein the event viewer discovers and redistributes the main event on the network on which it was created. And in one embodiment, the event organizer controls whether or not to allow one or more of the sub-events to be created on the event organizer's webpage.

In still another embodiment, the main events are selected from forums, parties, meetings, conferences, festivals, concerts, lectures, and get-togethers.

In one embodiment, the limited details comprise the number of the sub-events created, the event viewer who created the sub-events, and the number of the sub-event invitees for each the sub-event.

In another embodiment, the event viewer is a prospective and registered user of the social network website.

In one exemplary embodiment, the computer comprises a personal computer, a workstation, a notebook computer, a computer electronically interfaced with a network, a handheld device, a desktop, a tablet computer, a personal digital assistant, or a mobile phone.

In one or more exemplary embodiment, the method of the present invention further comprises interfacing with one or more computer-based social networks such as Facebook, Google+, LinkedIn, or Pinterest or an event-based social network such as Bindue Event Social.

In another embodiment, the method of present invention further provides a graphic interface comprising a create an event button, the button allowing the event organizer to create the main event.

In still another embodiment, the event viewer shares the main event on Facebook, using FConnect, or Twitter.

In a further embodiment, one or more the sub-events is public or private.

### BRIEF DESCRIPTION OF THE DRAWINGS

Various objects, features, aspects and advantages of the inventive subject matter will become more apparent from the following detailed description of exemplary embodiments, along with the accompanying figures in which like numerals represent like components.

FIG. 1 depicts a block diagram of a social networking system according to one embodiment of the present invention.

FIG. 2 depicts a flow chart of a method according to one or more embodiments of the present invention.

### DETAILED DESCRIPTION

One or more embodiments of the present invention provides a new method of creating a sub-event(s) based on a pre-existing event that allows users to connect and transact by sending a private message or public post to a selected group of users on a social network. In one or more embodiments, the present invention provides away for one or more persons or artificially intelligent entities to organize event subsets. In another embodiment, the present invention helps to organize, syndicate, make known and host a wide range of offshoot events such as forums, parties, meetings, festivals, concerts, lectures, get-togethers, and the like that are related to, but are not an integral part of, the main pre-existing event.

In an embodiment, an event is a party or a communication. In another embodiment, an event is a virtual or face-to-face meeting of two or more persons or smart entities. One or more embodiments of the present invention provide that these events can be codified and harnessed for users to enjoy or utilize more freely. In a further embodiment, a user is any human, cybernetic organism or smart technology such as an artificially intelligent technology, program, or robot. In another embodiment, some of the roles any user may play comprise an event organizer, promoter, business, event coordinator, band manager, party host, and the like. In still another embodiment, the entire scope of artificial intelligence programs and robots may be used for the aforementioned roles, but are not limited to the same roles.

As used in the description herein and throughout the claims that follow, the meaning of “a,” “an,” and “the” includes plural reference unless the context clearly dictates otherwise. Also, as used in the description herein, the meaning of “in” includes “into” and “on” unless the context clearly dictates otherwise.

As used herein, the social networking application of the present invention is a method referred to as Piggyback Event.

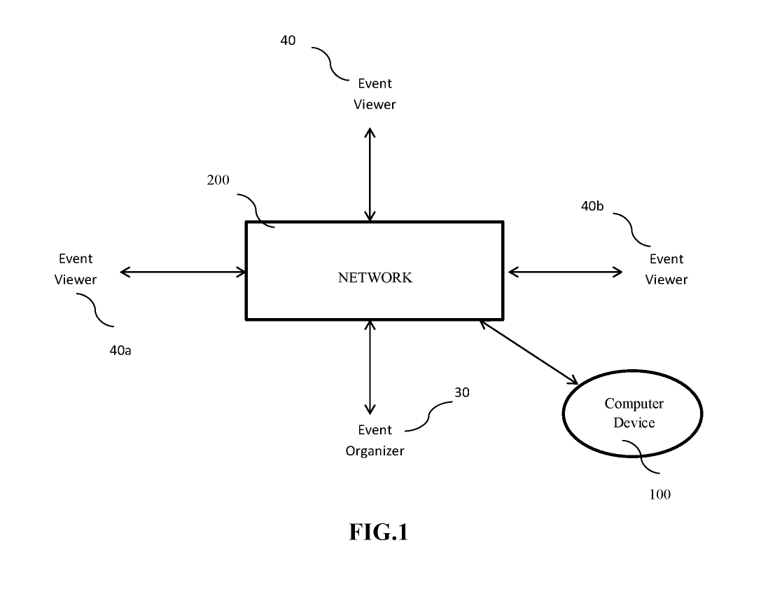

One exemplary embodiment, as shown in FIG. 1, illustrates a social networking system 200 for enabling communication between event viewers 40, 40a, 40b, and event organizer 30. In FIG. 1, the social networking system 200 includes a computer device 100. In one embodiment, computer device 100 comprises a personal computer, a workstation, a notebook computer, a computer electronically interfaced with a network, a handheld device, a desktop, a tablet computer, a personal digital assistant, a mobile phone, or the like.

In one or more embodiments, the method of the present invention exists within an event-based social network. In one or more embodiments, the method of the present invention interfaces with computer-based social networks such as Facebook, Google+, LinkedIn, or Pinterest (i.e., third party applications). In one embodiment, the method of the present invention exists within an event-based social network such as “Bindue Event Social.” In another embodiment, there are two different pathways to access the method, however, the present method can be integrated into any social networking platform, wherein rules for one or more registered user(s), privacy, and the like may not apply. In still another embodiment, users may gain access entry via a dialogue box, such as the user log-in through Twitter or Facebook accounts using their respective access credentials.

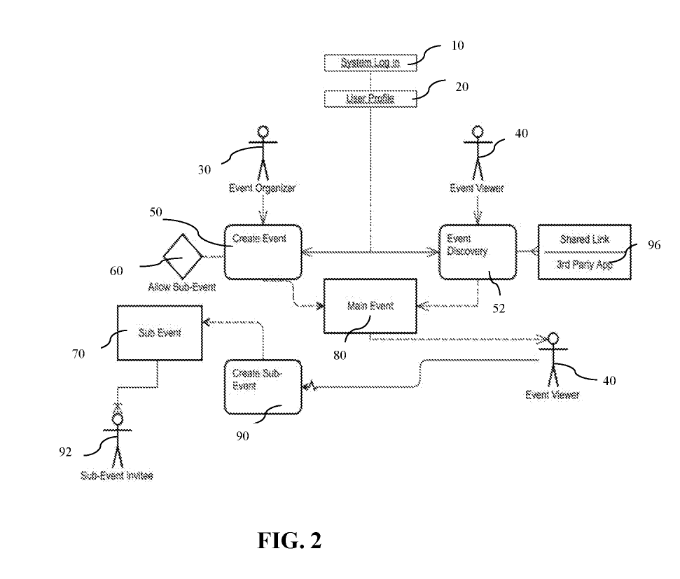

While those skilled in the art will appreciate that the present invention can be carried out in different embodiments, FIG. 2 provides a flowchart representing a method according to one of the present invention's embodiments. In this embodiment, executing the present invention involves the use of computer device 100 (as shown in FIG. 1). By way of example, event organizer 30, who is already a registered user of the social network website, using computer device 100, in system login 10, logs into his/her account using personalized credentials, i.e., email/password, at the social network's home page. In an embodiment, once event organizer 30 is authorized to enter the homepage, event organizer 30 can access his/her account containing a user profile 20 such as personal details, photos, events, interests, etc.

In another embodiment, after event organizer 30 has accessed his/her account, in step create event 50, he/she will have several ways to create main event 80. By way of example, main event 80 is created whether event organizer 30 is viewing his/her account, an event feed, or any other page within the website. In another embodiment, main event 80 is created by a graphic interface button (not shown) which is readily accessible to event organizer 30. By way of example, graphic interface (not shown) comprises “Create an Event” button, which upon clicking on said “Create an Event” button, event organizer 30 is redirected to an interface (not shown) that allows event organizer 30 to create main event 80. By way of example, main event 80 is a customized event page (including a webpage) displaying the details of main event 80 including date, time, location, and the like.

In an embodiment, event organizer 30 will be prompted to allow sub-event 60, (i.e., one or more piggyback events), to be created on his/her event page (not shown). In another embodiment, event organizer 30 may choose not to allow sub-event 60 (i.e., one or more piggybacks events) to be created on his/her webpage. Even though event organizer 30 may allow piggyback events to be created on his/her event webpage, event organizer 30 does not control who creates the piggyback event and what type of event it is, such as a party, a promotion, a wedding, a bachelor party, and the like.

As shown in 2, in an embodiment, event viewer 40, such as a prospective user, who is already a registered user of the social network website, using computer device 100, at step 10, logs into his/her account using personalized credentials, such as an email/password, at the social network's home page. In an embodiment, once event viewer 40 is authorized to enter the homepage, event viewer 40 can access his/her account containing user profile 20 such as personal details, photos, events, interests, and the like.

In an embodiment, event viewer 40 receives an invitation for a sub-event 60 (i.e., piggyback event) which is created by main event 80 page visitors/viewers. By way of example, event viewer 40 can view the event page (not shown) in event discovery 52 and review the event details, such as whether tickets are required for admission to the event, a list of the participants of the event, or the like. In another embodiment, event viewer 40 can discover main event 80 through a shared link or a third party application (App). In this embodiment, event viewer 40 discovers main event 80 on the network on which it was created (i.e., Bindue Event Social) or discovers it through a link to main event 80 that is shared on any other social media. For example, event viewer 40 can share main event 80 on Facebook, for instance using “FConnect,” Twitter and other social networks, i.e., a third party “app” or application.

In an exemplary embodiment, a piggyback event button, on main event 80, will be visible at the top of the event page for a visitor/viewer to click, if event organizer 30 has authorized sub-events 60 (i.e. Piggyback events) to be created on his/her event. By way of example, event viewer 40 viewing the event page can create a piggyback event by clicking on the tab “create piggyback” on main event page 80. Once clicked (selected), event viewer 40 will have the option to create sub-event page 90 (i.e., a new piggyback event). In addition to displaying a facility to create a new piggyback event, this sub-page (not shown) where piggyback event button resides allows event viewer 40 to observe limited details about the piggyback events created by any event viewers in relation to main event 80. In another embodiment, the limited details comprise the number of sub-events (i.e., piggyback events) 70 created, event viewer 40 who created them, and the number of sub-event invitees 92 for each sub-event 70.

Thus, specific embodiments of a piggyback event and method of use have been disclosed. It should be apparent, however, to those skilled in the art that many more modifications besides those already described are possible without departing from the inventive concepts herein. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A computer-implemented method for creating one or more sub-events in a social network comprising:
a) creating main events by an event organizer while said event organizer is viewing his/her account, an event feed, or any other page within a website;
b) redirecting said event organizer to an interface that allows said event organizer to create or revise said main event;
c) prompting said event organizer to allow one or more sub-events to be created on said event organizer's event page;
d) authorizing an event viewer to enter said social network homepage, wherein said event viewer receives an invitation for one or more sub-events created by said main event; and
e) allowing said event viewer to create a sub-event page and optionally allowing said event viewer to observe limited details about said sub-events page created by a plurality of event viewers in relation to said main event.

2. The method of claim 1, wherein said main event is a customized event webpage displaying the details of said main event comprising date, time, and location.

3. The method of claim 1, wherein said user is one or more persons or artificially intelligent entities.

4. The method of claim 1, wherein said event organizer does not control who creates said sub-events and the type of said sub-events.

5. The method of claim 1, wherein said event viewer discovers said main event through a shared link or a third party application, wherein said event viewer discovers and redistributes said main event on the network on which it was created.

6. The method of claim 1, wherein said event organizer controls whether or not to allow one or more of said sub-events to be created on said event organizer's webpage.

7. The method of claim 1, wherein said main events are selected from forums, parties, meetings, conferences, festivals, concerts, lectures, and get-togethers.

8. The method of claim 1, wherein said limited details comprise the number of said sub-events created, said event viewer who created said sub-events, and the number of said sub-event invitees for each said sub-event.

9. The method of claim 1, wherein said event viewer is a prospective and registered user of said social network website.

10. The method of claim 1, wherein said computer comprises a personal computer, a workstation, a notebook computer, a computer electronically interfaced with a network, a handheld device, a desktop, a tablet computer, a personal digital assistant, or a mobile phone.

11. The method of claim 1, further comprising interfacing with one or more computer-based social networks such as Facebook, Google+, LinkedIn, or Pinterest or an event-based social network such as Bindue Event Social.

12. The method of claim 1, further providing a graphic interface comprising a create an event button, said button allowing said event organizer to create said main event.

13. The method of claim 1, wherein said event viewer shares said main event on Facebook, using FConnect, or Twitter.

14. The method of claim 1, wherein said one or more said sub-events is public or private.
